(19) United States
(12) Patent Application Publication
(10) Pub. No.: US 2010/0213328 A1
(43) Pub. Date: Aug. 26, 2010

(54) Apparatus and Method for Retaining a Computer Input Device

(76) Inventors: Shaun Smith, Willow Grove, PA (US); Cory Brechbill, Schwenksville, PA (US); Jeffery Todd Theesfeld, Barto, PA (US); Jarrett Seng, Orefield, PA (US)

Correspondence Address: JONES, WALKER, WAECHTER, POITEVENT, CARRERE;& DENEGRE, L.L.P., 5TH FLOOR, FOUR UNITED PLAZA, 8555 UNITED PLAZA BOULEVARD, BATON ROUGE, LA, 70809, US

(21) Appl. No.: 12/392,967

(22) Filed: Feb. 25, 2009

(51) Int. Cl. A47B 96/06; F16M 13/00

(52) U.S. Cl. 248/122.1; 248/220.21

(57) ABSTRACT

In the specification and drawings an accessory cart is described and shown with a base; an arm connected to the base, the arm extending upward from the base; a bracket connected to the arm; a housing connected to the bracket. In the specification and drawings an apparatus for retaining a computer input device is also described and shown with a frame; and a strap having a first strap end portion connected to the frame and a second strap end portion connected to the frame, such that an opening is formed between the frame and the strap, at least one of the first strap end portion and the second strap end portion being adjustably connected to the frame such that the size of the opening can be adjusted.

### CROSS-REFERENCE TO RELATED APPLICATION

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BRIEF SUMMARY

An embodiment comprises an accessory cart comprising a base; an arm connected to the base, the arm extending upward from the base; a bracket connected to the arm; a housing connected to the bracket; and a plurality of electrical outlets connected to the housing. In an embodiment, the housing can further comprise a top side pivotally connected to the housing, wherein the top side further comprises a slot through the top side, the slot so dimensioned as to allow a flat screen display to extend from the interior of the housing to the exterior of the housing through the slot. An embodiment can further comprise a transparent screen removably connected to the top side. An embodiment can further comprise a computer located at least partially in the interior of the housing and a plurality of wheels connected to the base.

An embodiment can further comprise a power source electrically connected to at least one of the plurality of electrical outlets. The power source can also comprise a battery and/or an electrical connection to an external electrical outlet. In an embodiment, the power source can be located in the base. An embodiment can further comprise a power strip connected to the housing, the plurality of electrical outlets being located within the power strip.

In an embodiment, the housing can further comprise a lock bar extending across an interior portion of the housing, and can further comprise a means for adjustably connecting the lock bar to the housing. In an embodiment, the vertical position and horizontal position of the lock bar can be adjusted.

An embodiment can further comprise a beam connected to the bracket, the beam extending upward from the bracket, and can further comprise a mount rotatably connected to the beam. An embodiment can further comprise an accessory mounting bracket connected to the mount, and the accessory mounting bracket can comprise a ball joint bracket. The beam can comprise a longitudinal recess and can further comprise a recess cover located at least partially over the recess. In an embodiment, the recess cover can comprise an upper aperture and a lower aperture, such that a cable located in the recess can exit the recess through the upper aperture and the lower aperture.

In an embodiment, the housing can comprise a front side, a back side oriented toward the arm, a left side, and a right side; and an aperture through at least one of the sides. An embodiment can further comprise at least one cover removably positioned across at least a portion of the aperture. In an embodiment, collectively the at least one cover is removably positioned across substantially all of the at least one aperture. An embodiment can comprise a means for preventing a user from accessing the interior space of the housing through the aperture. An embodiment can comprise a means for preventing a user from accessing the interior space of the housing. An embodiment can comprise a means for preventing a user from accessing a data port of a computer located at least partially in the interior of the housing.

In an embodiment, the housing can further comprise an upper housing portion and a lower housing portion; and a panel positioned between the upper housing portion and the lower housing portion. In an embodiment, the panel is removably positioned between the upper housing portion and the lower housing portion. An embodiment can further comprise a ramp pivotally connected to the panel and can comprise a means for adjusting the height of the ramp.

An embodiment can further comprise a keyboard platform connected to the bracket. The keyboard platform can be adjustably connected to the bracket. An embodiment can further comprise a pivot platform pivotally engaged with the bottom surface of the keyboard platform, and can comprise a plurality of the pivot platforms pivotally engaged with the bottom surface of the keyboard platform. In an embodiment, the keyboard platform can further comprise a computer input device retainer connected to the keyboard platform. The computer input device retainer can be removably secured to the keyboard platform in a left or right position such that a user can move the computer input device retainer to either position to support a left-handed or right-handed user. In an embodiment, the computer input device retainer can further comprise a frame; and a strap having a first strap end portion connected to the frame and a second strap end portion connected to the frame, such that an opening is formed between the frame and the strap, at least one of the first strap end portion and the second strap end portion being adjustably connected to the frame such that the size of the opening can be adjusted.

An embodiment comprises an accessory cart comprising a base; an arm connected to the base, the arm extending upward from the base; a bracket connected to the arm; a housing connected to the bracket, the housing having a front side, a back side oriented toward the arm, a left side, and a right side; at least one aperture through at least one of the sides; and at least one cover, collectively the at least one cover being removably positioned across substantially all of the at least one aperture. In an embodiment, collectively the at least one cover is removably positioned across substantially all of each of the at least one aperture. In an embodiment, the housing can further comprise a top side pivotally connected to the housing. An embodiment can further comprise a power source in the base. An embodiment can further comprise a power strip, the power strip comprising a plurality of electrical outlets, the power strip being connected to the housing and being electrically connected to the power source.

An embodiment comprises an accessory cart comprising a base; an arm connected to the base, the arm extending upward from the base; a bracket connected to the arm; a housing connected to the bracket, the housing having a front side, a back side oriented toward the arm, a left side, and a right side; at least one aperture through at least one of the sides; and a means for preventing a user from accessing the interior space of the housing through the aperture. An embodiment can further comprise a means for preventing a user from accessing the interior space of the housing through each of the at least one aperture. In an embodiment, the housing can further comprise a top side pivotally connected to the housing. An embodiment can comprise a power source in the base. An embodiment can further comprise a power strip, the power strip comprising a plurality of electrical outlets, the power strip being connected to the housing and being electrically connected to the power source.

An embodiment comprises an accessory cart kit comprising a base; an arm connected to the base, the arm extending upward from the base; a bracket connected to the arm; a housing connected to the bracket, the housing having a front side, a back side oriented toward the arm, a left side, and a right side; at least one aperture through at least one of the sides; and a plurality of covers, the covers adapted to be removably positioned across at least a portion of the at least one aperture. In an embodiment, the plurality of covers are adapted to be removably positioned across at least a portion of the at least one aperture by a supervisor. In an embodiment, the plurality of covers can further comprise a first cover and a second cover, the first cover being smaller than the second cover, the first cover and the second cover being interchangeable such that a supervisor can removably position the first cover across a portion of the at least one aperture, or removably position the second cover across a larger portion of the at least one aperture. In an embodiment, collectively the plurality of covers are adapted to be removably positioned across substantially all of each of the at least one aperture by a supervisor.

An embodiment comprises an apparatus for retaining a computer input device comprising a frame; and a strap having a first strap end portion connected to the frame and a second strap end portion connected to the frame, such that an opening is formed between the frame and the strap, at least one of the first strap end portion and the second strap end portion being adjustably connected to the frame such that the size of the opening can be adjusted. In an embodiment, the frame can further comprise a cap removably connected to the frame, the cap creating an interior chamber within the frame. In an embodiment, the first strap end portion and the second strap end portion are adjustably connected to the interior of the frame. In an embodiment, the frame can further comprise a left side wall and a right side wall; and an aperture in each of the left side wall and the right side wall, a portion of the strap passing through the aperture in the left side wall and a portion of the strap passing through the aperture in the right side wall. An embodiment can comprise a means for adjusting the connection point of the first strap end portion and the second strap end portion.

An embodiment can comprise a plurality of masts connected to the interior of the frame. An embodiment can further comprise a cavity in the first strap end portion and a cavity in the second strap end portion, at least one of the masts being removably located within each of the cavities. An embodiment can comprise at least two cavities in the first strap end portion and at least two cavities in the second strap end portion, at least one of the masts being removably located within each of the cavities. In an embodiment, the plurality of masts can comprise at least eight masts, the masts being arranged in two parallel rows. In an embodiment, the plurality of masts can comprise at least twelve masts, the masts being arranged in three parallel rows. In an embodiment, the frame can further comprise a left side wall and a right side wall; and at least two apertures in each of the left side wall and the right side wall, a portion of the strap passing through at least one of the apertures in the left side wall and at least one of the apertures in the right side wall.

In an embodiment, the strap is engaged with at least two of the masts. In an embodiment, each of the first strap end portion and the second strap end portion are engaged with at least two of the masts. In an embodiment, each of the first strap end portion and the second strap end portion can further comprise an expanded head structure, the expanded head structure of the first strap end portion being engaged with at least two of the masts, and the expanded head structure of the second strap end portion being engaged with at least two of the masts. An embodiment can further comprise at least one rib located within the interior of the frame, the strap being secured between the rib and the frame. An embodiment can comprise at least one frame rib connected to the frame and at least one cap rib connected to the cap, the strap being secured between the frame rib and the cap rib. In an embodiment, at least one of the expanded head structures is engaged with at least two of the masts, and is movable for engagement with at least two of the masts located in a first direction, and movable for engagement with at least one of the masts located in a second direction, the first direction and the second direction being non parallel. In an embodiment, the frame can further comprise a left side wall and a right side wall; and at least two apertures in each of the left side wall and the right side wall, a portion of the strap passing through at least one of the apertures in the left side wall and at least one of the apertures in the right side wall.

In an embodiment, at least one of the first strap end portion and the second strap end portion can comprise an expanded head structure, the expanded head structure being engaged with at least two of the masts. In an embodiment, at least one of the first strap end portion and the second strap end portion can comprise an expanded head structure, the expanded head structure being engaged with at least two of the masts located on a first side of the expanded head structure, and with at least two of the masts located on a second side of the expanded head structure. An embodiment can comprise at least one rib located within the interior of the frame, the strap being secured between the rib and the frame. An embodiment can comprise at least one frame rib connected to the frame and at least one cap rib connected to the cap, the strap being secured between the frame rib and the cap rib. In an embodiment, at least one of the first strap end portion and the second strap end portion is engaged with at least one of the masts, and is movable for engagement with at least one of the masts located in a first direction, and movable for engagement with at least one of the masts located in a second direction, the first direction and the second direction being non parallel. In an embodiment, the first direction and the second direction are substantially perpendicular.

In an embodiment, the length of the strap is between about 12 centimeters and about 24 centimeters. In an embodiment, the size of the opening is so dimensioned as to allow a computer mouse to be inserted into the opening and secured therein. An embodiment can comprise a computer mouse located within the opening, the mouse being secured to the frame by the strap. In an embodiment, the strap is flexible. In an embodiment, the frame is connected to a work station. In an embodiment, the work station comprises a keyboard platform. In an embodiment, the frame is removably connected to the keyboard platform in a left or right position such that a user can move the frame to either position to support a left-handed or right-handed user.

An embodiment comprises an apparatus for retaining a computer input device comprising a frame; and a strap having a first strap end portion connected to the frame and a second strap end portion connected to the frame, such that an opening is formed between the frame and the strap, and such that the connection of the frame to at least one of the first strap end portion and the second strap end portion is movable in a first direction. In an embodiment, the connection of the frame to at least one of the first strap end portion and the second strap end portion is movable in a second direction, the first direction and the second direction being non parallel. In an embodiment, the first direction and the second direction are substantially perpendicular.

An embodiment comprises a method of retaining a computer input device comprising removing a cap of a frame; adjusting the size of an opening between a strap and the frame; replacing the cap of the frame; and securing a computer input device between the strap and the frame. In an embodiment, securing a computer input device can further comprise securing a computer mouse between the strap and the frame. In an embodiment, adjusting the size of the opening can further comprise moving a point of connection between the strap and the frame. In an embodiment, adjusting the size of the opening can further comprise moving at least two points of connection between the strap and the frame. In an embodiment, adjusting the size of the opening can further comprise disengaging the strap from at least one mast. In an embodiment, adjusting the size of the opening can further comprise engaging the strap to at least one mast located in a first direction.

The above summary is not intended to describe each illustrated embodiment or every possible implementation. The figures and the detailed description which follow, however, do particularly exemplify these embodiments.

### BRIEF DESCRIPTION OF THE SEVERAL VIEWS OF THE DRAWINGS

FIG. 1 is a perspective view of an embodiment described herein.

FIG. 2 is a side elevation view of an embodiment described herein.

FIG. 3 is a rear elevation view of an embodiment described herein.

FIG. 4 is a perspective view of an embodiment described herein.

FIG. 5 is a perspective view of an embodiment described herein.

FIG. 6 is a perspective view of an embodiment described herein.

FIG. 7a is a perspective view of an embodiment described herein.

FIG. 7b is a perspective view of an embodiment described herein.

FIG. 8a is a perspective view of an embodiment described herein.

FIG. 8b is a perspective view of an embodiment described herein.

FIG. 9a is a perspective view of an embodiment described herein.

FIG. 9b is a perspective view of an embodiment described herein.

FIG. 10a is a perspective view of an embodiment described herein.

FIG. 10b is a perspective view of an embodiment described herein.

FIG. 11 is a perspective view of an embodiment described herein.

FIG. 12 is a perspective view of an embodiment described herein.

FIG. 13 is a perspective view of an embodiment described herein.

FIG. 14 is an exploded perspective view of an embodiment described herein.

FIG. 15 is a perspective view of an embodiment described herein.

FIG. 16 is a perspective view of an embodiment described herein.

FIG. 17 is a perspective view of an embodiment described herein.

FIG. 18 is a front elevation view of an embodiment described herein.

FIG. 19 is a sectional view taken along line 19-19 of FIG. 18.

FIG. 20 is a plan view of an embodiment described herein.

FIG. 21 is a plan view of an embodiment described herein.

FIG. 22 is a plan view of an embodiment described herein.

FIG. 23 is a sectional view taken along line 23-23 of FIG. 22.

FIG. 24 is a plan view of an embodiment described herein.

FIG. 25 is a perspective view of an embodiment described herein.

FIG. 26 is an exploded perspective view of an embodiment described herein.

FIG. 27 is a plan view of an embodiment described herein.

### DETAILED DESCRIPTION

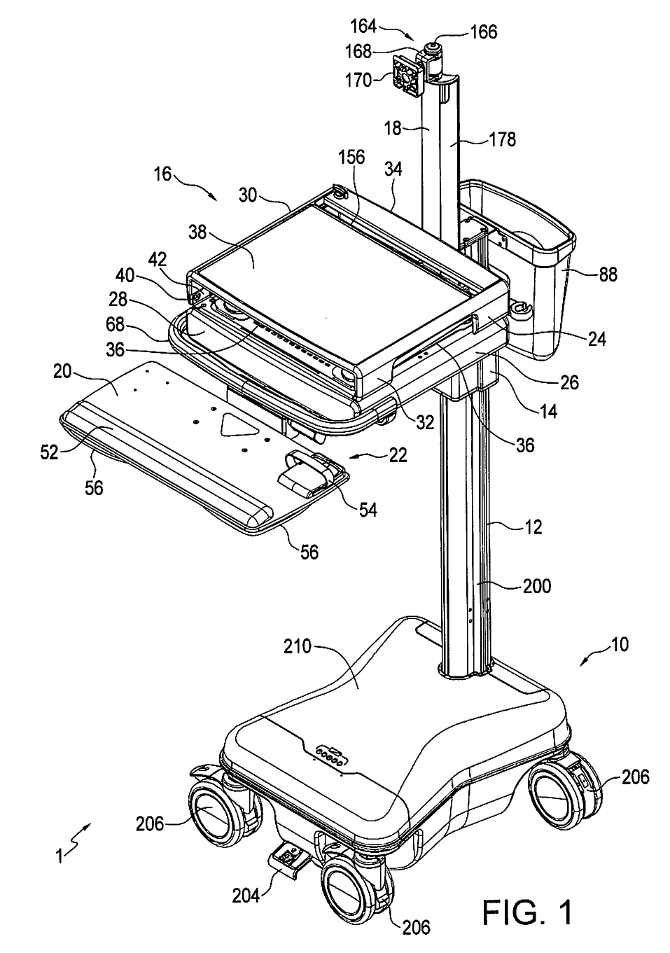

As shown in the accompanying drawings, an embodiment is an accessory cart. As shown in FIG. 1, an embodiment of the accessory cart 1 has a base 10. An arm 12 is connected to the base 10 and extends upward from the base 10. A bracket 14 is slidably engaged with the arm 12. A housing 16 is connected to the bracket 14. A beam 18 is also connected to the bracket 14, and extends upward from the bracket 14. A keyboard platform 20 is adjustably connected to the bracket 14. Keyboard platform 20 has a computer input device retainer 22 connected to the top of the keyboard platform 20.

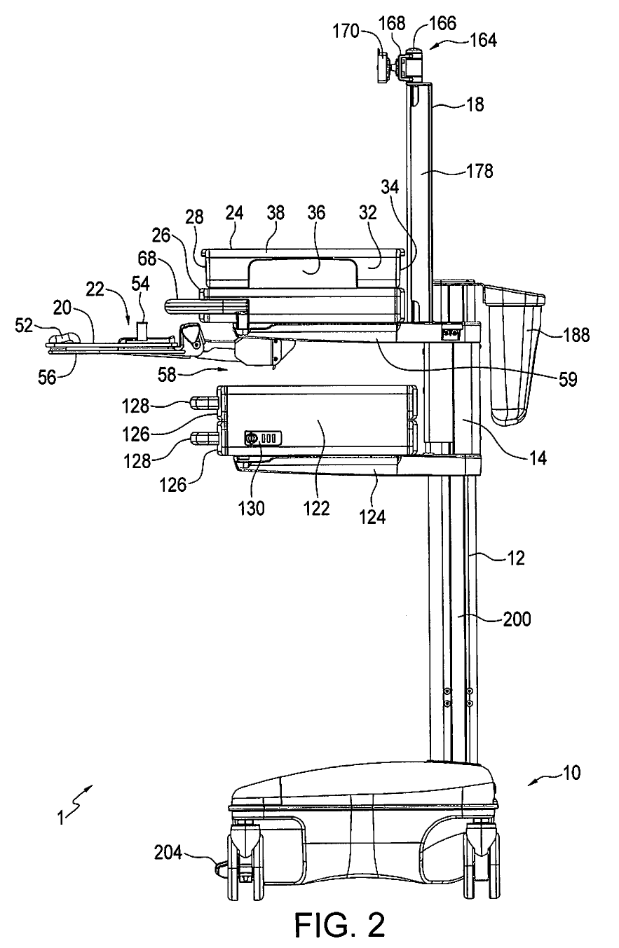

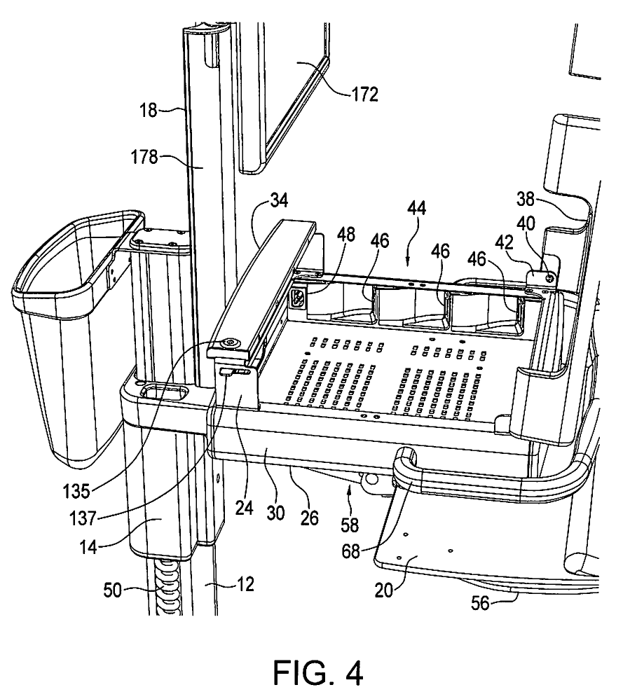

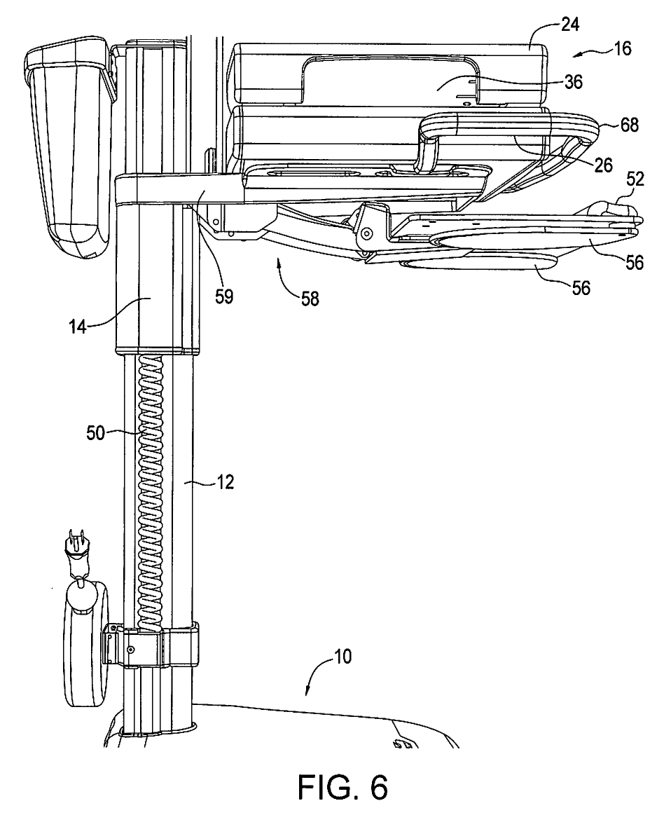

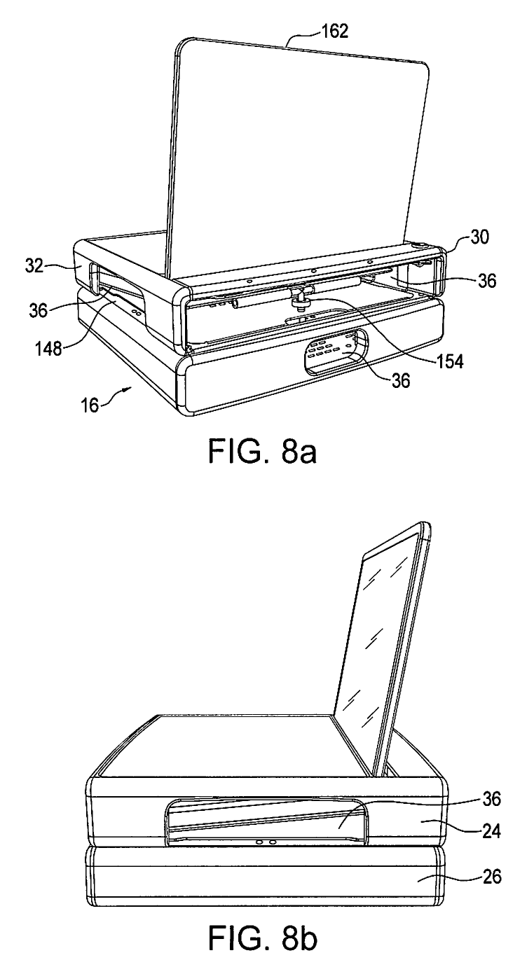

Referring to the embodiments shown in FIGS. 1, 2 and 4, the housing 16 has an upper housing portion 24 and a lower housing portion 26. Although the embodiment of the housing 16 shown in FIGS. 2 and 4 is generally cube shaped, the housing 16 can also be other shapes, such as round or triangular. The housing 16 has a front side 28, a left side 30, a right side 32 and a back side 34. The back side 34 is oriented toward the arm 12. The housing 16 can have apertures 36 in the front side 28 (shown in FIG. 1), the left side 30 (shown in FIG. 6), the right side 32 (shown in FIG. 2) and the back side 34 (shown in FIG. 8b). The apertures can allow access to the interior of the housing 16. The housing 16 has a top side 38 that is pivotally connected to the housing 16 at pivot point 40. The pivot point 40 can allow the top side 38 to pivot open and allow access to the interior space of the housing 16. The top side 38 can pivotally connect to housing 16 by an apparatus such as a hinge, nut and bolt, screw, or other connection that allows the top side 38 to pivot open. The top side 38 is shown in an open position in FIG. 4 and in a closed position in FIG. 2. In the embodiment shown in FIG. 4, the housing 16 includes a strut 42 to which top side 38 is pivotally connected. The top side can have tamper proof screws or bolts, a lock or other methods or apparatuses to reduce a user's access to the interior of the housing 16 and keep top side 38 in a closed position. The housing 16 also has a housing handle 68 connected to the lower housing portion 26. The housing handle 68 can assist a user in moving the accessory cart 1.

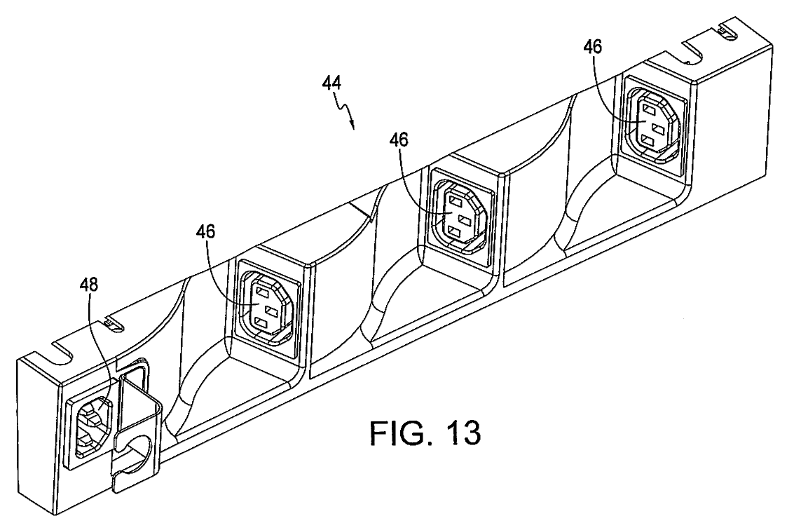

Referring to the embodiments shown in FIGS. 4 and 13, a power strip 44 is located within the housing 16. In FIG. 13, the power strip 44 is shown isolated from the housing. The power strip 44 has three electrical outlets 46 and one electrical inlet 48. The electrical inlet 48 can be electrically connected to a power source in the base 10 by a coiled power cord 50. The electrical outlets 46 can provide electricity for a computer, a lap top computer, a display screen, a bar code scanner, medical equipment or any other device which uses electricity. Since the power strip 44 is separated from the base 10 and located in the housing 16, multiple electrical devices can be plugged into the electrical outlets 46 and the power cables from the devices do not have to extend down to the base 10. In the embodiment shown in FIG. 13, the electrical outlets 46 are International Electrotechnical Commission (“IEC”) electrical outlets. More specifically, the electrical outlets 46 are IEC-C13 outlets. The electrical inlet 48 is an IEC-C14 inlet. Adapters can be provided to allow for the connection of different types of devices to the IEC-C13 outlets.

Referring now to the embodiments shown in FIGS. 2 and 6, keyboard platform 20 is adjustably connected to the bracket 14. The keyboard platform 20 is adjustably connected to the bracket 14 by a keyboard support mechanism 58 which is itself connected to mounting bracket 59, which is in turn connected to the top of bracket 14. In an embodiment, the keyboard platform 20 can be connected or adjustably connected to the bracket 14 by connecting the keyboard platform 20 to the housing 16 or other structure, which is in turn connected to the bracket 14. An example an embodiment of the keyboard support mechanism 58 is shown and described in U.S. Pat. No. 5,292,097, U.S. Pat. No. 5,924,664 and/or U.S. Pat. No. 6,883,764 each of which is hereby incorporated by reference in its entirety. The keyboard platform 20 can be constructed of materials such as plastic, metal, wood, resin, white phenolic resin or any other suitable material. For convenience to a user of the keyboard platform 20, the keyboard platform 20 can have a wrist support 52, a computer input device retainer 22 and/or a mouse pad. The wrist support 52 can be made of a length of a cushioning or supportive material, including without limitation silicone gel, beads or foam encased in fabric or other materials suitable for human skin movement, in order to support the wrists of a user in an ergonomically beneficial position when utilizing a keyboard located on the keyboard platform 20. Wrist support 52 can be secured to the surface of the keyboard platform 20 by methods or apparatuses such as hook-and-loop fabric tape, adhesive, guide pins, bolts, screws, rivets or other means.

Referring to FIGS. 2 and 6, the keyboard platform 20 can have a separate pivot platform 56, which is pivotally engaged to the under-surface of the platform 20 such that a user can pivot the pivot platform 56 out from under the keyboard platform 20 for use, or pivot the pivot platform 56 out of the way underneath the keyboard platform 20 when not in use. A second pivot platform 56 can be attached on the opposite side, or the pivot platform 56 can be removably secured to either side such that a user can secure the pivot platform 56 to either side to accommodate the user's handedness. As described above, the keyboard platform 20 can feature ambidextrous components for the convenience of its users.

Referring still to FIG. 2, an embodiment is a computer input device retainer 22. The computer input device retainer 22 has one or more straps 54 that are capable of stretching in all directions to restrain a computer accessory, e.g. a mouse, pointer or other peripheral device. The computer input device retainer 22 can be secured to the platform 20 in a right or left position by methods or apparatuses such as hook-and-loop fabric tape, adhesive, guide pins, bolts, screws, rivets or other means. The computer input device retainer 22 also can be removably secured to the platform 20 such as by using a pin and hole arrangement, such that the computer input device retainer 22 can be positioned either in a left or right position.

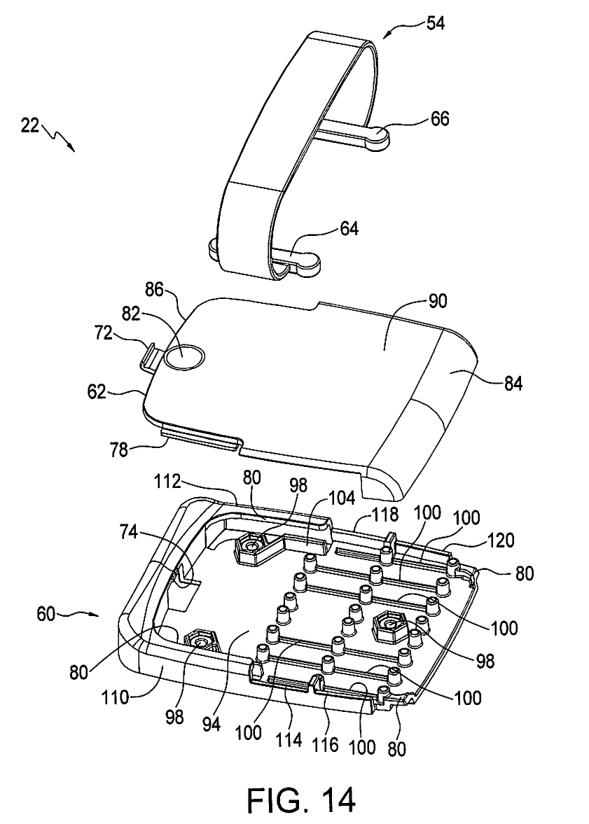

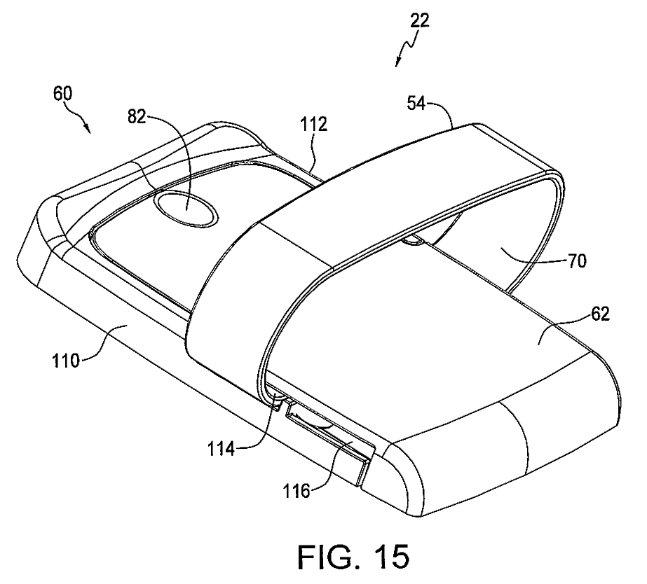

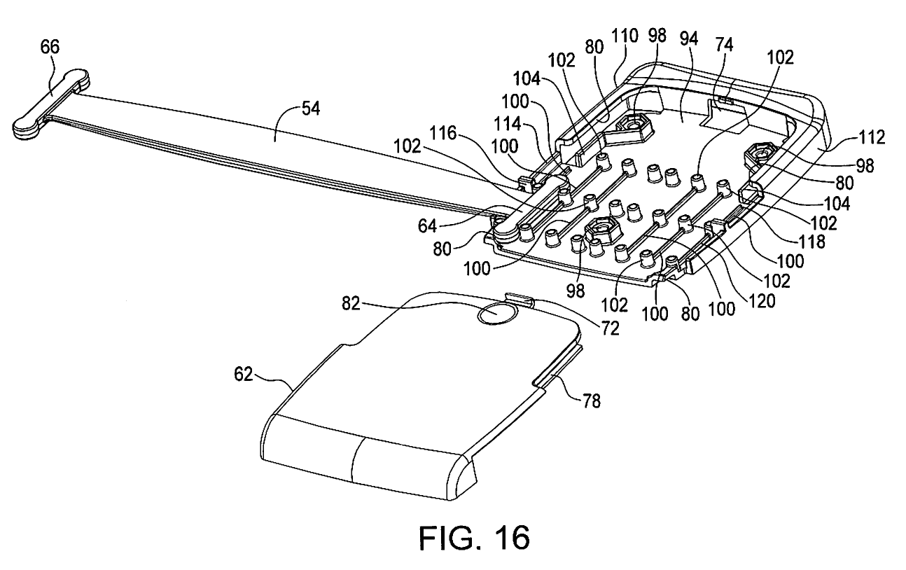

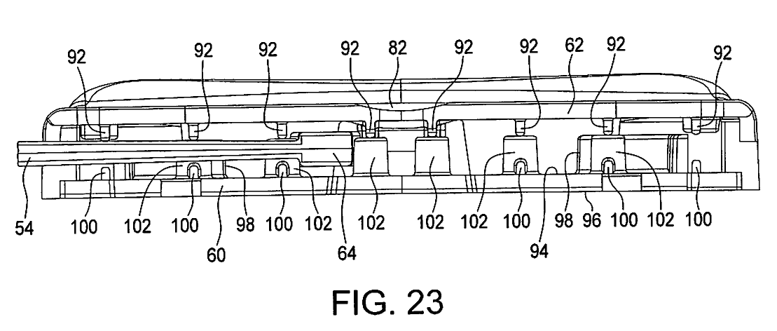

Referring now to the embodiments shown in FIGS. 14, 15 and 16, the computer input device retainer 22 has a frame 60. A strap 54 is adjustably connected to the interior of the frame 60 (best shown in FIGS. 16 and 23.) As shown in FIG. 15, the frame 60 includes a cap 62 which is removably connected to the frame 60. The cap 62 of the frame 60 is shown in a removed position in FIGS. 14 and 16.

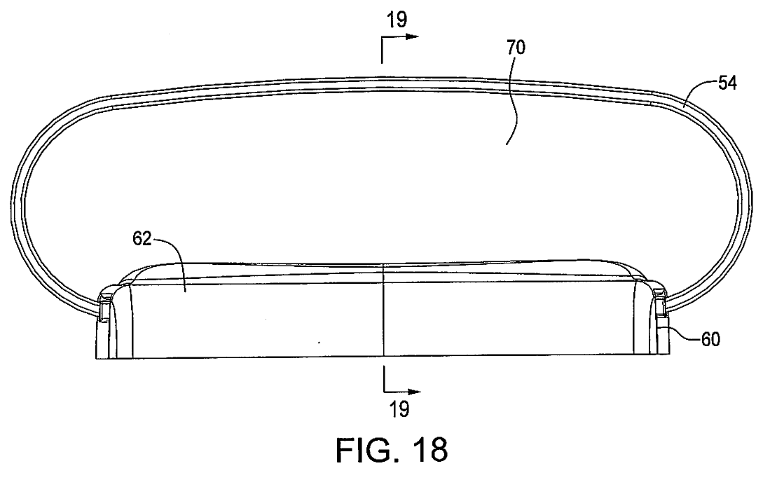

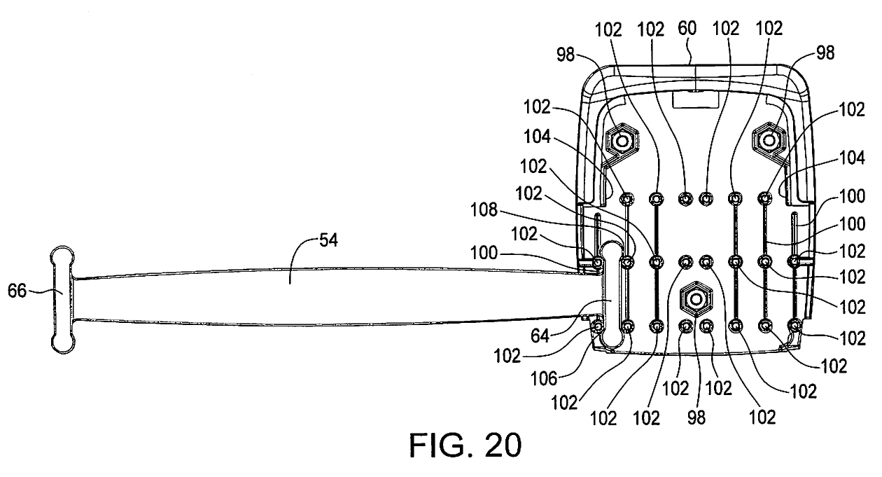

Referring to the embodiments shown in FIGS. 14 and 16, the strap 54 has a first strap end portion 64 and a second strap end portion 66. The first strap end portion 64 and the second strap end portion 66 include an expanded head structure. In the embodiments shown in FIGS. 14 and 16, the expanded head structure is generally “T” shaped. The first strap end portion 64 and the second strap end portion 66 can be made of the same or a different material than that of the remainder of the strap. For example, the first strap end portion 64 and the second strap end portion 66 can be made of a material such as plastic or metal, and the remainder of the strap can be made of rubber. As shown in FIG. 18, an opening 70 is formed between the frame 60 and the strap 54 when the first strap end portion 64 and the second strap end portion 66 are connected to the frame 60. In an embodiment, the strap 54 can be about 18 centimeters in length when in a flat position (shown in FIG. 20), and when measured from the first strap end portion 64 to the second strap end portion 66. In another embodiment, the length of the strap 54 can be from about 5 centimeters to about 30 centimeters. In another embodiment, the length of the strap 54 can be from about 12 centimeters to about 24 centimeters. In still another embodiment, the length of the strap 54 can be from about 15 centimeters to about 21 centimeters. In an embodiment, the strap 54 is flexible, and can be made of a flexible material such as rubber or latex.

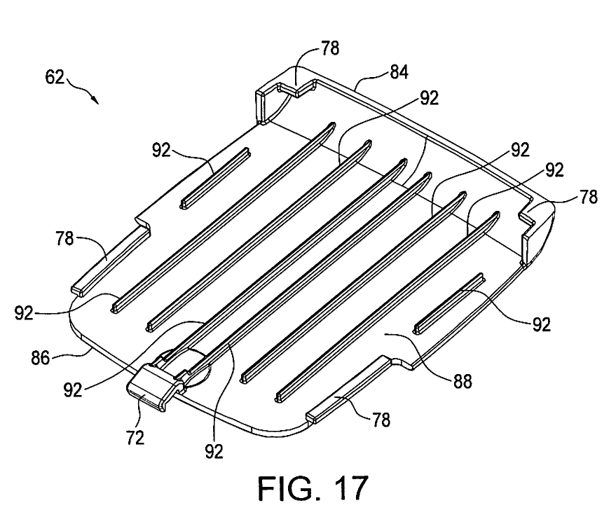

Referring now to the embodiments shown in FIGS. 14, 17 and 19, the frame 60 includes a cap 62 that can be removably connected to the frame 60. The cap 62 has a latch 72 that releasably connects to a socket 74 of frame 60 by engaging shoulder 76. The cap 62 also has wedges 78 located near the front 84 and back 86 of each side of the cap 62. The top surface of wedges 78 can engage the bottom surface of wedge engaging members 80, which are located on the front and back of each side of the frame 60. Wedges 78 engage wedge engaging members 80 when the cap 62 is connected to the frame 60, thereby securing the cap 62 to the frame 60. The cap 62 also has a notch 82 near the back of the cap 62. The notch 82 can aid a user in removing the cap 62 from the frame 60. The cap 62 has an interior side 88 and an exterior side 90. As shown in FIG. 17, the cap 62 has eight parallel cap ribs 92 (described in greater detail below) located on the interior side 88 of cap 62. The cap 62, the frame 60 can be constructed of materials such as plastic, metal, wood, resin, white phenolic resin or any other suitable material.

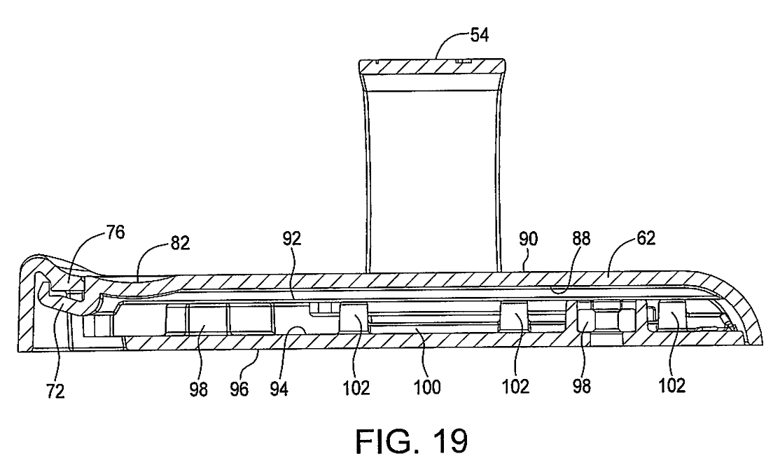

The cap 62 can be removed from the frame 60 by applying downward pressure at or near the notch 82, which disengages the latch 72 from the shoulder 76 of the socket 74. The cap 62 is then slid in the front direction (or to the right as shown in FIG. 19), which disengages the wedges 78 from the wedge engaging members 80. The cap 62 can be replaced on the frame 60 by reversing this process.

Referring now to the embodiments shown in FIGS. 14, 16 and 23, the frame 60 has an interior side 94 and an exterior side 96. Three keepers 98 located on the interior side 94 of the frame 60. The keepers 98 have a hexagonally shaped interior profile, and can secure a hexagonally shaped nut against rotational movement. The frame 60 can be connected to a work station, such as a keyboard platform 20 (shown in FIG. 1), by placing the frame 60 on the keyboard platform 20, locating a hexagonally shaped nut in each keeper 98, and passing a bolt through the bottom of keyboard platform 20 and threadedly engaging the nut with the bolt. In addition to the keyboard platform 20, the frame 60 can also be connected to other work stations, such as an accessory cart, a desk, or a laptop computer.

Referring still to the embodiments shown in FIGS. 14, 16 and 23, the frame 60 has six parallel frame ribs 100 connected to the interior side 94 of frame 60. The frame 60 also has a series of masts 102 connected to the interior of the frame 60. In the embodiments shown in FIGS. 14, 16 and 23, the masts 102 are connected to the interior side 94 of the frame. The masts 102 can also be connected to the interior of the frame 60 by connecting the masts 102 to the interior side 88 of the cap 62. The masts 102 can be round, column shaped projections as shown in FIGS. 14, 16 and 23. In another embodiment, the masts can also be other shapes such as square, triangular or have a curved shape which conforms to the profile of the expanded head structure. As shown in FIG. 16, the masts can also be a wall 104.

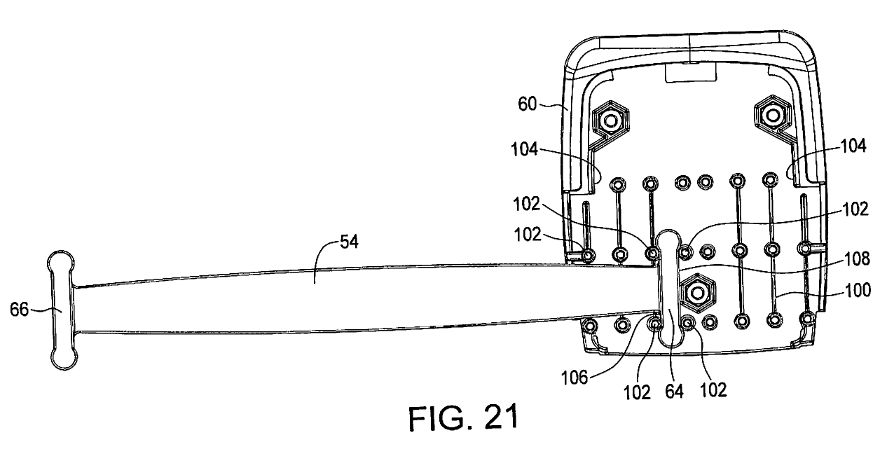

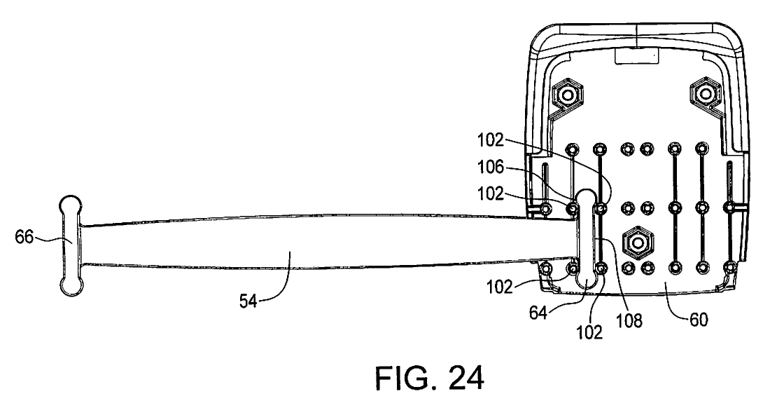

Referring now to FIGS. 20, 21, 22 and 24, the masts 102 and 104 are arranged in three parallel rows, each row having eight masts. The expanded head structure of the first strap end portion 64 is engaged with two masts 102 located on a first side 106 of the expanded head structure, and with two masts 102 located on a second side 108 of the expanded head structure, thus securing the expanded head structure between four of the masts 102. The size of the opening 70 (shown in FIG. 18 and formed when both the first strap end portion 64 and the second strap end portion 66 are connected to the frame 60) can be adjusted by removing the cap 62 (shown in FIG. 16) from the frame 60 and exposing the interior of the frame 60. The first strap end portion 64 is then moved in a first direction from the position shown in FIG. 20, to the position shown in FIG. 21 or 24, thereby engaging the expanded head structure of the first strap end portion 64 with at least one mast located in a first direction. The cap 62 is then replaced on the frame 60. In the embodiments shown in FIGS. 15 and 18, the second strap end portion 66 is adjustably connected to the interior of the frame 60 in the same manner as described above for the first strap end portion 64. In an embodiment, the first strap end portion 64 and/or the second strap end portion 66 can be adjustably or moveably connected to the frame 60 by including tracks in the frame 60, and slidably connecting the first strap end portion 64 and/or the second strap end portion 66 to the tracks. Stops, such as pins, could be used to keep the first strap end portion 64 and/or the second strap end portion 66 in a position on the track.

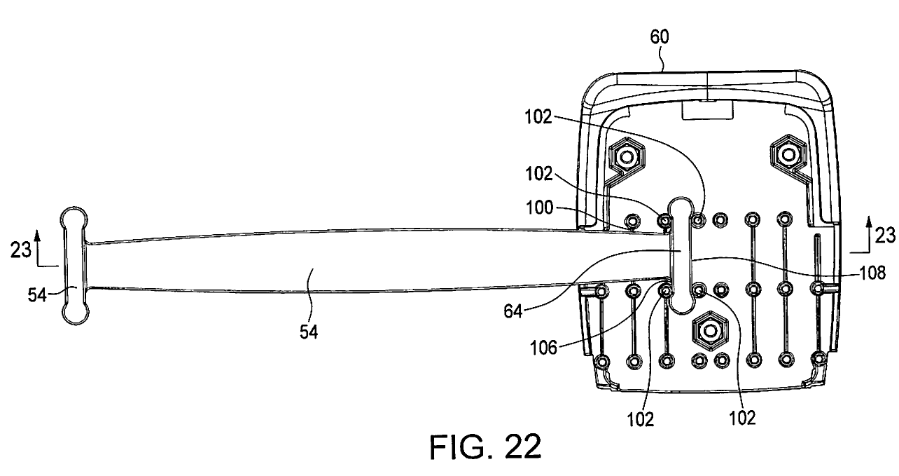

Adjusting the size of the opening 70 can allow for computer input devices of various sizes and shapes to be inserted into the opening 70 and secured to the frame 60 by the strap 54. A computer input device can include devices such as a mouse, tack ball, bar code scanner or a microphone. In addition to adjusting the size of the opening 70, the connection of the frame 60 to the first strap end portion 64 and/or the second strap end portion 66 can be moved in a second direction from the position shown in FIG. 21, to the position shown in FIG. 22.

Referring now to FIGS. 14, 15 and 16, the frame 60 has a left side wall 110 and a right side wall 112. Left side wall 110 has two apertures 114 and 116, and right side wall 112 has two apertures 118 and 120. The apertures 114, 116, 118 and 120 can allow a portion of the strap 54 to pass from the interior to the exterior of the frame 60. In the embodiment shown in FIG. 15, a portion of the strap 54 passes through the left side wall 110 at aperture 114, and through the right side wall 112 at aperture 118. In the embodiment shown in FIG. 16, only the first strap end portion 64 is shown connected to the frame 60, and a portion of the strap 54 passes through the left side wall 110 at aperture 116. The second strap end portion 66 could also be connected to the frame 60 and could pass through the right side wall 112 at aperture 120 or at aperture 118.

Referring now to FIG. 23, a portion of the strap 54 is secured between three frame ribs 100 and three complementary cap ribs 92. In the embodiment shown in FIG. 20, a portion of the strap 54 would be secured between one frame rib 100 and one cap rib 92 once the cap 62 was connected to the frame 60. In an embodiment, the frame ribs 100 and the cap ribs 92 can keep, or help keep a portion of the strap 54 in a position.

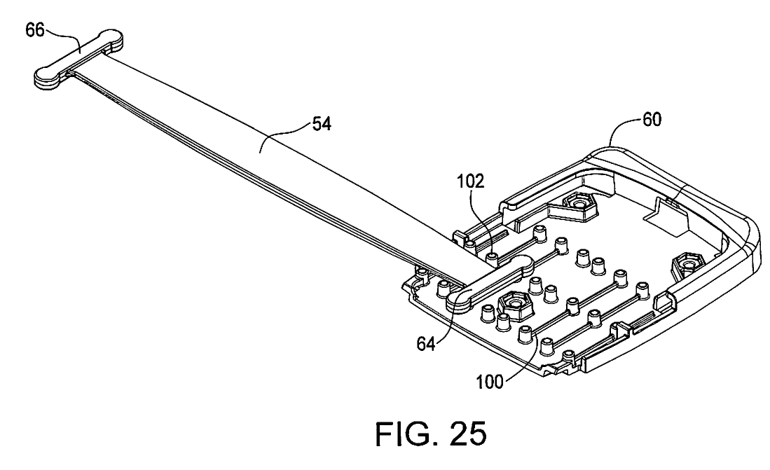

As shown in the embodiment depicted in FIG. 25, the first strap end portion 64 and/or the second strap end portion 66 can be engaged with the masts 102 by forming two cavities in the bottom of both the first strap end portion 64 and the second strap end portion 66, and placing the cavities over the masts 102. The size of the frame ribs 100 and/or the cap ribs 92 (shown in FIG. 17) could be reduced or eliminated to allow additional room for the first strap end portion 64 and/or the second strap end portion 66 to fit within the frame 60.

In operation, in the embodiments shown in FIGS. 20, 21, 22 and 24 the size of the opening 70 (shown in FIG. 18 and formed when both the first strap end portion 64 and the second strap end portion 66 are connected to the frame 60) can be adjusted by removing the cap 62 (shown in FIG. 16) from the frame 60 and exposing the interior of the frame 60. The first strap end portion 64 can then be moved in a first direction from the position shown in FIG. 20, to the position shown in FIG. 21 or 24, thereby engaging the expanded head structure of the first strap end portion 64 with at least one mast located in a first direction. The cap 62 is then replaced on the frame 60. A computer input device, such as a computer mouse, can then be inserted into the opening 70 and secured to the frame 60 by the strap 54. If the size of the opening 70 is too large or too small to secure the computer mouse to the frame 60, the above process can be repeated to adjust the size of the opening 70 accordingly. The size of the opening 70 can also be adjusted by the above process if the computer mouse is replaced with a larger or smaller computer mouse, or if the computer mouse is replaced with a different type of computer input device.

Referring now to the embodiments shown in FIGS. 1 and 2, the housing 16 is connected to the bracket 14. The housing 16 is connected to the bracket 14 by mounting bracket 59, which is in turn connected to the top of bracket 14. As shown in FIG. 2, a second housing 122 is connected to the bracket 14. The second housing 122 is connected to the bracket 14 by second mounting bracket 124 which is in turn connected to the bottom of bracket 14. Two drawers 126 are slidably located within the second housing 122. Each drawer 126 has a handle 128 that can aid in the opening or closing of the drawers 126. The drawers 126 can have a locking mechanism for locking the drawers 126 within the second housing 122. In the embodiment shown in FIG. 2, the locking mechanism is a keyed lock 130. Although the embodiment depicted in FIG. 2 is shown with two drawers 126 located within the second housing 122, the second housing 122 could also have one drawer, three or more drawers or no drawers at all. In an embodiment, a laptop computer could be located in the upper housing portion 24, and a desktop computer could be located in the second housing 122. The desktop computer could output a signal to one or more display screens connected to beam 18. A vital signs monitor could also be connected to beam 18. The second housing 122 could also have any or all of the features described herein for the housing 16.

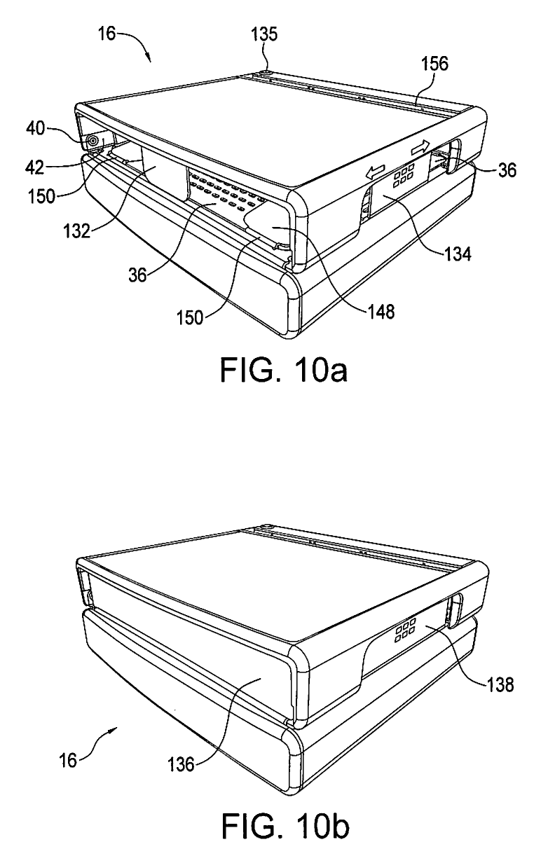

Referring now to the embodiments shown in FIGS. 10a and 10b, the upper housing portion 24 can have covers 132, 134, 136 and 139 removably positioned across apertures 36. In FIG. 10a, covers 132 and 134 are positioned across a portion of the apertures 36, while in FIG. 10b, covers 136 and 139 are collectively positioned across substantially all of the apertures. Covers can be positioned across substantially all of each of the apertures located in the front side 28, left side 30, right side 32 and back side 34, thereby preventing a user from accessing the interior space of the housing 16. As used herein, preventing a user from accessing the interior space of the housing 16 does not mean preventing any access whatsoever. Instead, preventing a user from accessing the interior space of the housing 16 is defined as preventing any access to the interior space of the housing 16 that would allow a user to tamper with or physically manipulate a device, such as computer located within the housing 16, without additional keys, lock combinations, and/or tools. As used herein, preventing a user from accessing the interior space of the housing 16 does not include accessing a computer located within the housing 16 via devices such as mouse or keyboard whether wired or wireless, that were previously connected, such as by a supervisor or security technician, to a computer located within the housing 16, prior to the use of the accessory cart 1 by a user. Preventing a user from accessing the interior space of the housing 16 also does not include physically manipulating a device such as a computer located within the housing 16 via a device which is built into the accessory cart 1 at the time of manufacture, or a device which is incorporated into the accessory cart 1 prior to the use of the accessory cart 1 by a user. A user is defined as one who uses the accessory cart 1 for its intended purpose. As used herein, a user does not include entities such as a manufacturer, distributor, security technician and/or a supervisor of a user. As used herein, a supervisor is defined as one who supervises a user, and/or as one who has been given security access to the accessory cart 1, such as a security technician or hospital administrator.

Referring still to the embodiments shown in FIGS. 10a and 10b, covers 132, 134, 136 and 138 can also be positioned such that a user is prevented from accessing some or all of the data ports of a computer located within the housing 16, but some other access to the interior space of the housing 16 may still be possible. In the embodiment shown in FIG. 10a, cover 134 can slide to different positions and then lock into place in order to cover different portions of apertures 36. The cover 134 can be locked into place, for example by security screws (described below). Alternatively, cover 134 could have teeth on a top edge that engage complementary teeth of the top side 38 when the top side 38 is in a closed position; and the bottom edge of cover 134 could slide along a track. In such an embodiment, the cover 134 could be removed by opening the top side 38 and sliding the cover 134 clear of the aperture 36, or by disconnecting the cover 134 from the housing 16. Instead of or in addition to sliding, the covers 132 and 134 could also have teeth on the top and bottom edge such that the covers 132 and 134 could be statically repositioned across a portion of the apertures 36 which corresponds to the location of the data ports of a computer, such that a user is prevented from accessing the data ports. Although covers 132 and 136 are depicted as solid plates in FIGS. 10a and 10b, the covers can also be structures such as vertical and/or horizontal bars, wire mesh or other suitable structures.

Referring still to the embodiments shown in FIGS. 10a and 10b, an embodiment can be an accessory cart kit that can include a plurality of covers, such as covers 132, 134, 136 and 138. The kit can have a plurality of covers that can be removably positioned across at least a portion of at least one of the apertures 36 by a supervisor. As shown in FIG. 10a, covers 132 and 134 are removably positioned across a portion of two apertures 36. The kit can have a plurality of covers with each of the covers being the same size, or the kit can have a plurality of covers with one or more of the covers being of a different size than at least one other of the covers. The kit can have a first cover (for example, cover 132) and a second cover (for example, cover 136) with the first cover being smaller than the second cover. The first cover and the second cover can be interchangeable.

In operation, in an embodiment of the accessory cart kit a supervisor can removably position a first cover 132 across a portion of aperture 36. Alternatively, a supervisor can removably position a second cover 136 across a larger portion of aperture 36, for example to decrease a user's access to the interior space of the housing 16. In an embodiment, a plurality of covers can be provided which allow a supervisor to select the level of a user's access to the interior of the housing 16. For example, a supervisor can prevent a user from accessing the interior space of the housing 16 by removably positioning covers across substantially all of each of the apertures in the front side 28, left side 30, right side 32 and back side 34. Alternatively, a supervisor can remove all of the covers, thus allowing open access to the interior space of the housing 16. A supervisor can also select various levels of access between open and no access by selecting covers from the kit, and removably positioning one or more of covers across the apertures at selected positions. For example, a supervisor can select a smaller cover from the kit, and removably position the cover at a position which corresponds to a data port of a computer located within the interior of the housing. This could prevent a user from accessing the data port of the computer, but still allow some access to the interior space of the housing 16.

Referring now to FIG. 4, the housing 16 has a lock 135 for locking the top side 38 in a closed position. Lock 135 is connected to tab 137 which can engage top side 38 and keep top side 38 in a closed position. Although lock 34 is shown as a keyed lock, other types of locks, such as a combination lock can also be used. Security screws can also be used to connect the various parts of the accessory cart 1 and can increase the difficulty of removing various parts or accessing certain areas of the accessory cart 1. An example of a security screw is a Phillips head screw with an additional raised projection in the head of the screw. The raised projection prevents a standard Phillips screw driver from engaging the screw, and instead uses a specifically designed screw driver with a head structure adapted to engage the head of the screw.

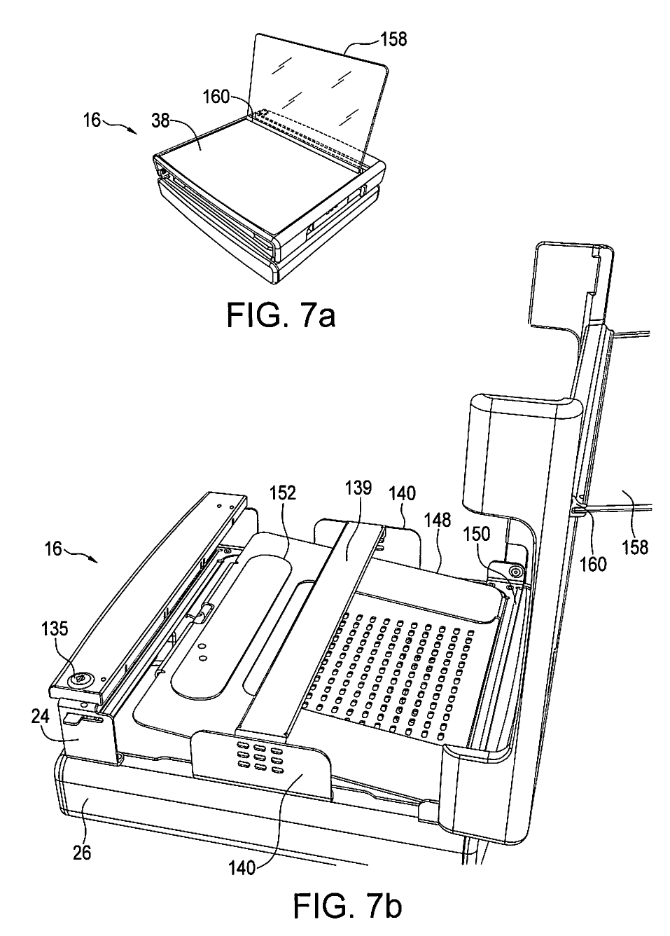

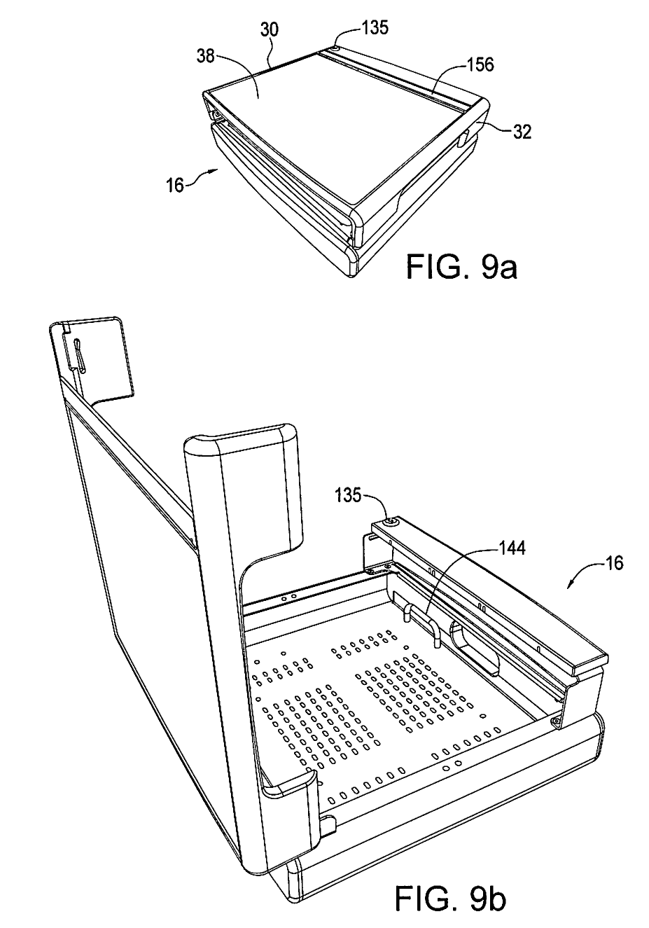

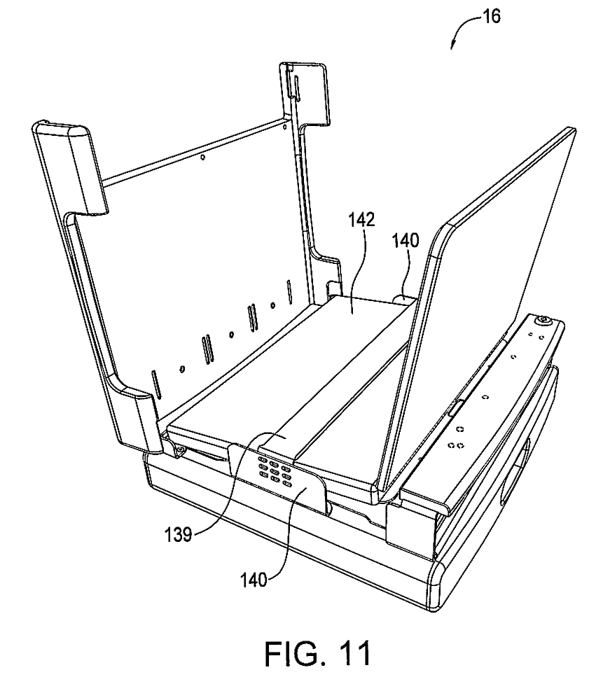

Referring now to the embodiments shown in FIGS. 7b and 11, the housing 16 has a lock bar 139 extending across an interior portion of the housing 16. The lock bar 139 is adjustably connected to the housing 16 via housing struts 140. The vertical and horizontal position of the lock bar 139 can be adjusted by connecting the lock bar 139 at different positions on the housing struts 140. The lock bar 139 can be connected to the housing struts 140 by devices such as screws, security screws, nuts and bolts, or other suitable devices. In an embodiment, the housing struts 140 can be slidably mounted to the housing 16, such that the horizontal position of the lock bar 139 can be adjusted. Further, the lock bar 139 can be slidably mounted to the housing strut 140, such that the vertical and/or horizontal position of the lock bar can be adjusted. In the embodiment shown in FIGS. 7b and 11, the lock bar 139 can keep a laptop computer 142 or a desktop computer secured in place when the top side 38 is in an open position. In the embodiment depicted in FIG. 9b a curved bar 144 is connected to the interior of the housing at the two ends of the curved bar 144. A device such as a laptop computer can be secured to the curved bar 144 by a lock and cable apparatus which connects the curved bar 144 to a slot in the laptop computer, such as KENSINGTON® security slot.

Referring now to the embodiment shown in FIG. 4, the housing 16 has a panel 146 that is removably positioned between the upper housing portion 24 and the lower housing portion 26. In an embodiment, the panel 146 can rest on ledges in the housing and the panel 146 can be removed without additional tools. In another embodiment, the panel 146 can be attached to the housing 16 by devices such as screws, security screws, nuts and bolts, or other suitable devices. A device such as a laptop computer can be located in the upper housing portion 24 and rest on the panel 146. Additional components such as wires, power inverters or other accessories can be located in the lower housing portion 26. As shown in FIG. 9b, the panel 146 can be removed, thus creating additional space in the interior of the housing 16.

Referring now to the embodiment shown in FIGS. 7b, 8b and 10a, a ramp 148 is pivotally connected to the panel 146 at pivot points 150. The height of the rear portion 152 of the ramp 148 can be adjusted by turning thumbscrew 154. In an embodiment, adjusting the height of the ramp 148 can adjust the height of the display screen of a laptop computer placed on the ramp.

Referring now to the embodiment shown in FIG. 9a, the upper housing portion 24 has a slot 156 through top side 38. The slot 156 extends across the top side 38 from the left side 30 to the right side 32. The slot 156 is about forty centimeters in length and about three centimeters in width and can allow a flat screen display 162 (shown in FIGS. 8a and 8b), such as a display screen of a laptop computer, to extend from the interior of the housing 16, through the slot 156, and to the exterior of the housing 16. As flat screen displays are produced in different widths and thicknesses, in an embodiment, the dimensions of the slot 156 can be so dimensioned as to allow a flat screen display to extend from the interior of the housing 16 to the exterior of the housing through the slot 156.

Referring now to FIGS. 7a, and 7b, a transparent screen 158 is removably connected to top side 38 by sliding within screen track 160. The transparent screen 158 can be secured to the screen track 160 by tightly wedging within the screen track 160, or can be secured to the screen track 160 by devices such as screws, security screws, nuts and bolts, or other suitable devices. The transparent screen 158 can provide a barrier that prevents spilled liquids from penetrating the interior of the housing 16 through slot 156. Further, the transparent screen 158 can provide a barrier which protects a flat screen display that extends through slot 156. In an embodiment, a flat screen display does not extend through slot 156, and a cover can be removably positioned across the slot 156.

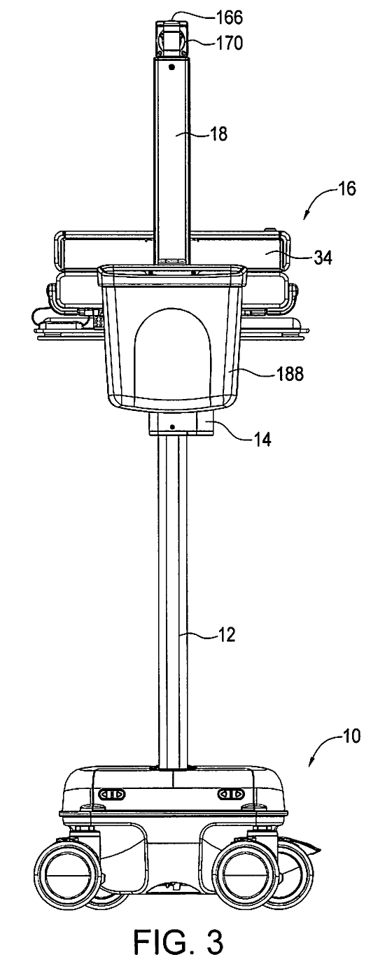

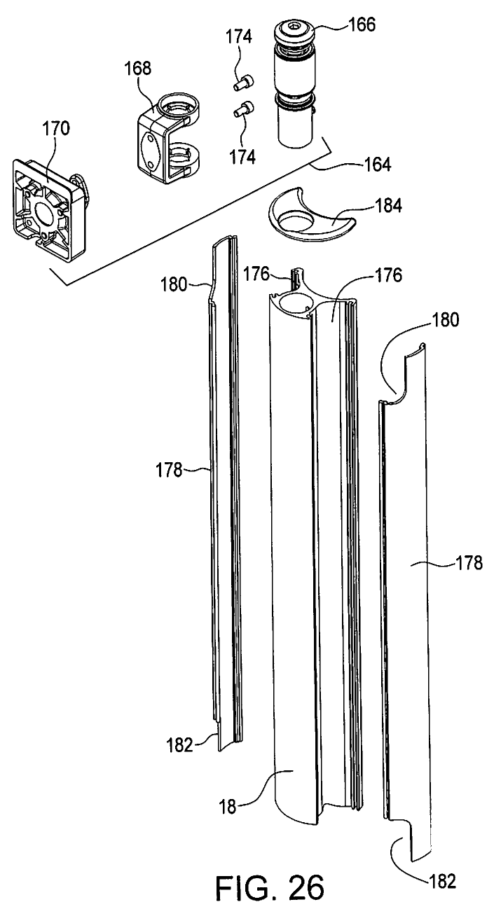

Referring now to the embodiments shown in FIGS. 1, 2 and 3, beam 18 is connected to and extends upward from bracket 14. Beam 18 is connected to bracket 14 via mounting bracket 59, which is in turn connected to the top of bracket 14. In an embodiment, the beam 18 can be any kind of upward projection which can support an accessory, such as a flat screen display or a vital signs monitor. A rotatable mount 164 is connected to the distal end of the beam 18. The mount 164 includes a joint 166 rotatably engaged with extension 168 which is engaged with an accessory mounting bracket 170 by bolts 174 (shown in FIG. 26). In an embodiment, the accessory mounting bracket 170 is a ball joint bracket, such as a VESA® compliant ball joint bracket. The Video Electronics Standards Association (VESA®) is an organization of technology based companies proposing standards for the video electronics market. One standard for mounting attachment of video displays is the VESA® Flat Display Monitor Interface standard or VESA®FDMI™. The VESA® FDMI™ Standard defines mounting interfaces, hole patterns, and associated cable/power supply locations for LCD monitors, plasma displays and other flat panel devices. Under this standard, VESA® compliant video displays are equipped with either a 75×75 mm mounting hole pattern or a 100×100 mm mounting hole pattern. Further, VESA® compliant mounting patterns may be found on other types of devices that could also be attached to the accessory mounting bracket 170. Alternatively, other bracket types could be used to allow for attachment of other accessories. The accessory mounting bracket 170 is further adapted, by use of a ball joint, to provide for up to sixty degrees of tilt by the attached monitor 172 (shown in FIG. 4) in a horizontal or vertical direction for additional adjustment. The ball joint of the bracket 170 also allows the monitor 172 to rotate 360 degrees such that it may be viewed in a portrait or landscape position.

Referring now to FIG. 26, the beam 18 and some of its components are shown in an exploded perspective view and isolated from the remainder of the accessory cart. Beam 18 has longitudinal recesses 176 along their length that can be used to restrain power, data or other cables associated with accessories mounted to the accessory mounting bracket 170. Recess covers 178 can be placed over recesses 176 to retain cables within recesses 176. Recess covers 178 can snap into place over the recesses 176 to conceal cables from observers. Recess covers 178 could also slide into place or could attach to the beam 18 over the recesses 176 by any other suitable means. Recess cap 184 can be attached to the distal end of beam 18 and can cover the distal ends of recesses 176. Recess covers 178 also have upper apertures 180 and lower apertures 182. When an accessory, such as a monitor, is attached to the accessory mounting bracket 170, the associated cables can be run (from the monitor or other accessory, for example) through an upper aperture 180 of a recess cover 178, down a recess 176 and out of a lower aperture 182 of a recess cover 178. The cables can then be connected, for example, to electrical outlets 46 or a computer located within the housing. 16.

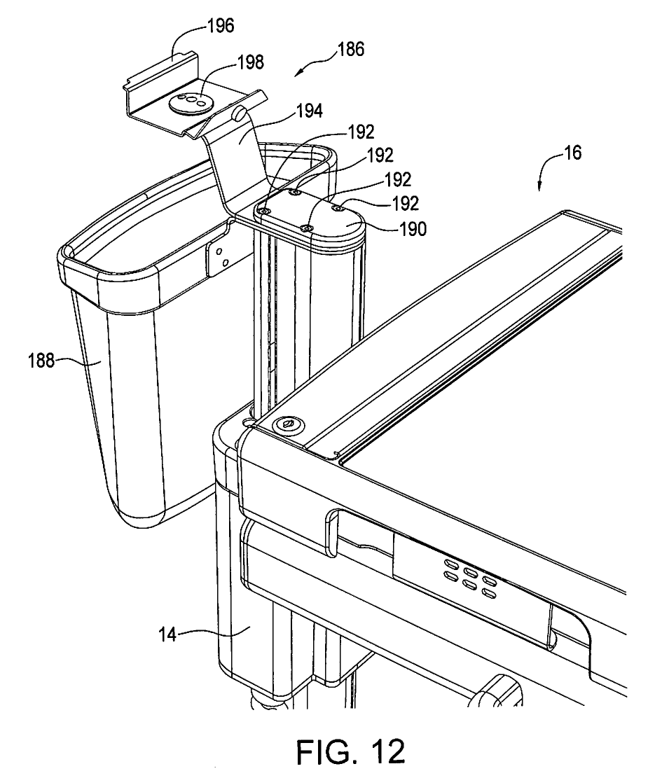

Referring now to the embodiment depicted in FIG. 12, an accessory mount 186 and a container 188 are connected to the upper end of arm 12. Arm cap 190 is also connected the upper end of arm 12. Screws 192 secure the container 188, accessory mount 186 and arm cap 190 to the upper end of arm 12. As opposed to or in addition to screws 192, the accessory mount 186, container 188 and/or arm cap 190 can be connected to arm 12 by devices such as security screws, nuts and bolts, or other suitable devices. In an embodiment, the accessory mount 186 and container 188 can be removed, and the arm cap 190 can be secured directly to the upper end of arm 12.

Container 188 has an open top and can be used to hold or store various items such as medical supplies, patient charts, batteries, or any other items. Accessory mount 186 includes a mounting extension 194 and a pivot bracket 196 pivotally connected to the mounting extension 194. A friction washer (not shown), such as a Belleville washer, can be inserted between the pivot bracket 196 and the mounting extension 194 to create pivotal friction between the pivot bracket 196 and the mounting extension 194. The degree of pivotal friction can be adjusted by turning friction bolt 198 to compress or decompress the friction washer. Accessories, such as a flat panel display or a vital signs monitor can be mounted to the pivot bracket 196.

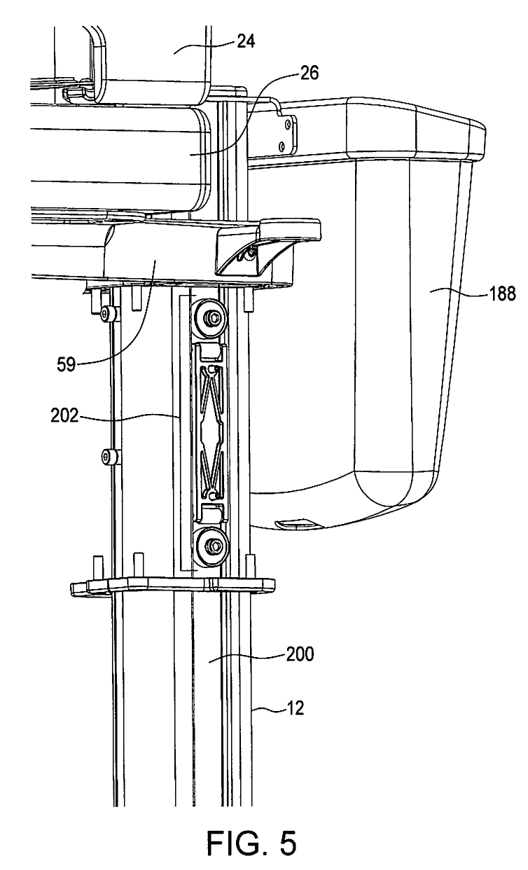

Referring now to the embodiment depicted in FIG. 2, bracket 14 is connected to arm 12 by slidably engaging with the arm 12. In the embodiment depicted in FIG. 5, the outer cover of bracket 14 has been removed. In this embodiment, the arm 12 has a track 200, and at least one roller assembly 202 engaged with the bracket and slidably engaged with the track 200. A counter-balance mechanism is located within arm 12 and is operatively engaged with the roller assembly 202, such that the roller assembly 202 and the attached bracket can slide vertically along track 200, with the counter-balance mechanism balancing the weight of the bracket and any other components that are connected to the bracket. The counter-balance mechanism can comprise devices such as a gas, pneumatic or hydraulic spring, or any other suitable device. The counter-balance mechanism can also include a releasable lock which locks the roller assembly 202 and the attached bracket in a vertical position along the track 200. When the releasable lock is released, the bracket is free to move vertically along the arm 12 with the roller assembly 202 sliding along the track 200. Referring again to FIG. 2, the base 10 includes a peddle 204 that is operatively engaged with the counter-balance mechanism, such that depressing the peddle 204 can release the releasable lock and allow the bracket to be raised or lowered by a user with exertion of a minimal force. Another example of a bracket, roller assembly and/or counter-balance mechanism that can be used in an embodiment is described in an application entitled “Wall-Mounted Accessory Holder,” filed contemporaneously herewith by inventors Matthew Sommerfield, Jarrett Seng and Jeffery Theesfeld and assigned to Humanscale Corporation, which is hereby incorporated by reference. In an embodiment, another bracket, roller assembly and/or counter-balance mechanism can be used.

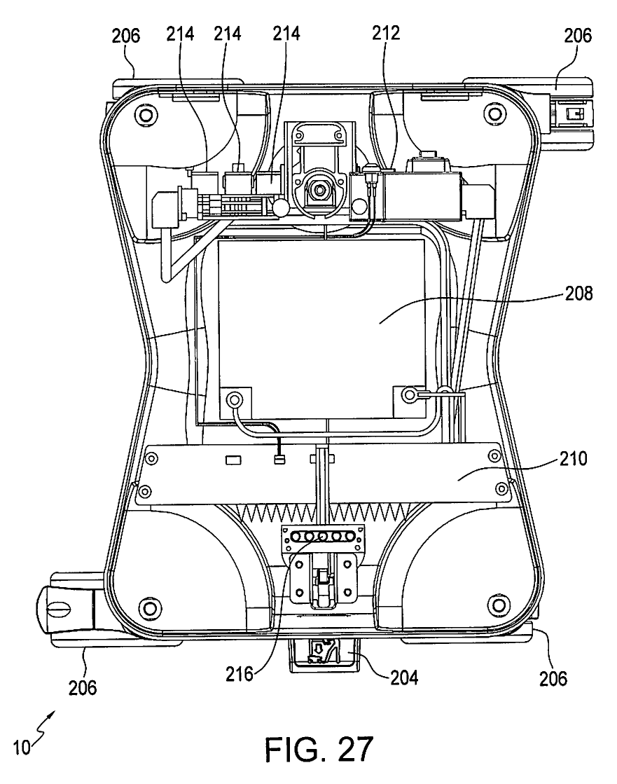

Referring now to FIG. 27, base 10 is depicted in a plan view with the top shell 210 (shown in FIG. 1) removed. Base 10 has four wheels 206 which can allow the accessory cart to be rolled to a desired location. Located within the base 10 is a power source which can be electrically connected, such as by a power cable, to electrical inlet 48 located within housing 16 (shown in FIG. 4). In an embodiment, the power source can be any source of electrical power, such as a battery, capacitor, fuel cell, generator or any other device which transmits or is capable of producing electricity. In the embodiment depicted in FIG. 27, the power source includes a battery 208 which is electrically connected to power supply 210, which is itself electrically connected to base electrical inlet 212. Base electrical inlet 212 can be electrically connected by a power cable to an external electrical outlet, such as a wall outlet which outputs alternating current. When base electrical inlet 212 is electrically connected to an external electrical outlet, alternating current is transmitted to power supply 210, which converts the alternating current to direct current. Power supply 210 then transmits direct current to the battery 208 or to other locations in or on the accessory cart 1. The base also includes three base electrical outlets 214 electrically connected to power supply 210. The base electrical outlets 214 can provide electricity for devices which use electrical power. A battery monitor 216 is electrically connected to the battery 208 and can display the charge level of the battery 208.

The embodiments shown in the drawings and described above are exemplary of numerous embodiments that may be made within the scope of the appended claims. It is contemplated that numerous other configurations may be used, and the material of each component may be selected from numerous materials other than those specifically disclosed. In short, it is the applicant's intention that the scope of the patent issuing herefrom will be limited only by the scope of the appended claims.

We claim:

1. An apparatus for retaining a computer input device comprising:
a. a frame; and
b. a strap having a first strap end portion connected to the frame and a second strap end portion connected to the frame, such that an opening is formed between the frame and the strap, at least one of the first strap end portion and the second strap end portion being adjustably connected to the frame such that the size of the opening can be adjusted.

2. The apparatus of claim 1 wherein the frame further comprises a cap removably connected to the frame, the cap creating an interior chamber within the frame.

3. The apparatus of claim 2 wherein the first strap end portion and the second strap end portion are adjustably connected to the interior of the frame.

4. The apparatus of claim 3 wherein the frame further comprises:
a. a left side wall and a right side wall; and
b. an aperture in each of the left side wall and the right side wall, a portion of the strap passing through the aperture in the left side wall and a portion of the strap passing through the aperture in the right side wall.

5. The apparatus of claim 3 further comprising a means for adjusting the connection point of the first strap end portion and the second strap end portion.

6. The apparatus of claim 2 further comprising a plurality of masts connected to the interior of the frame.

7. The apparatus of claim 6 further comprising a cavity in the first strap end portion and a cavity in the second strap end portion, at least one of the masts being removably located within each of the cavities.

8. The apparatus of claim 6 further comprising at least two cavities in the first strap end portion and at least two cavities in the second strap end portion, at least one of the masts being removably located within each of the cavities.

9. The apparatus of claim 8 wherein the plurality of masts comprise at least eight masts, the masts being arranged in two parallel rows.

10. The apparatus of claim 8 wherein the plurality of masts comprise at least twelve masts, the masts being arranged in three parallel rows.

11. The apparatus of claim 10 wherein the frame further comprises:
a. a left side wall and a right side wall; and
b. at least two apertures in each of the left side wall and the right side wall, a portion of the strap passing through at least one of the apertures in the left side wall and at least one of the apertures in the right side wall.

12. The apparatus of claim 6 wherein the strap is engaged with at least two of the masts.

13. The apparatus of claim 6 wherein each of the first strap end portion and the second strap end portion are engaged with at least two of the masts.

14. The apparatus of claim 13 wherein each of the first strap end portion and the second strap end portion further comprise an expanded head structure, the expanded head structure of the first strap end portion being engaged with at least two of the masts, and the expanded head structure of the second strap end portion being engaged with at least two of the masts.

15. The apparatus of claim 14 further comprising at least one rib located within the interior of the frame, the strap being secured between the rib and the frame.

16. The apparatus of claim 14 further comprising at least one frame rib connected to the frame and at least one cap rib connected to the cap, the strap being secured between the frame rib and the cap rib.

17. The apparatus of claim 16 wherein at least one of the expanded head structures is engaged with at least two of the masts, and is movable for engagement with at least two of the masts located in a first direction, and movable for engagement with at least one of the masts located in a second direction, the first direction and the second direction being non parallel.

18. The apparatus of claim 17 wherein the frame further comprises:
a. a left side wall and a right side wall; and
b. at least two apertures in each of the left side wall and the right side wall, a portion of the strap passing through at least one of the apertures in the left side wall and at least one of the apertures in the right side wall.

19. The apparatus of claim 6 wherein at least one of the first strap end portion and the second strap end portion further comprise an expanded head structure, the expanded head structure being engaged with at least two of the masts.

20. The apparatus of claim 6 wherein at least one of the first strap end portion and the second strap end portion further comprise an expanded head structure, the expanded head structure being engaged with at least two of the masts located on a first side of the expanded head structure, and with at least two of the masts located on a second side of the expanded head structure.

21. The apparatus of claim 6 further comprising at least one rib located within the interior of the frame, the strap being secured between the rib and the frame.

22. The apparatus of claim 6 further comprising at least one frame rib connected to the frame and at least one cap rib connected to the cap, the strap being secured between the frame rib and the cap rib.

23. The apparatus of claim 6 wherein at least one of the first strap end portion and the second strap end portion is engaged with at least one of the masts, and is movable for engagement with at least one of the masts located in a first direction, and movable for engagement with at least one of the masts located in a second direction, the first direction and the second direction being non parallel.

24. The apparatus of claim 23 wherein the first direction and the second direction are substantially perpendicular.

25. The apparatus of claim 1 wherein the length of the strap is between about 12 centimeters and about 24 centimeters.

26. The apparatus of claim 1 wherein the size of the opening is so dimensioned as to allow a computer mouse to be inserted into the opening and secured therein.

27. The apparatus of claim 1 further comprising a computer mouse located within the opening, the mouse being secured to the frame by the strap.

28. The apparatus of claim 1 wherein the strap is flexible.

29. The apparatus of claim 1 wherein the frame is connected to a work station.

30. The apparatus of claim 29 wherein the work station comprises a keyboard platform.

31. The apparatus of claim 30 wherein the frame is removably connected to the keyboard platform in a left or right position such that a user can move the frame to either position to support a left-handed or right-handed user.

32. An apparatus for retaining a computer input device comprising:
a. a frame; and
b. a strap having a first strap end portion connected to the frame and a second strap end portion connected to the frame, such that an opening is formed between the frame and the strap, and such that the connection of the frame to at least one of the first strap end portion and the second strap end portion is movable in a first direction.

33. The apparatus of claim 32 wherein the connection of the frame to at least one of the first strap end portion and the second strap end portion is movable in a second direction, the first direction and the second direction being non parallel.

34. The apparatus of claim 33 wherein the first direction and the second direction are substantially perpendicular.

35. A method of retaining a computer input device comprising:
a. removing a cap of a frame;
b. adjusting the size of an opening between a strap and the frame;
c. replacing the cap of the frame; and
d. securing a computer input device between the strap and the frame.

36. The method of claim 35 wherein securing a computer input device further comprises securing a computer mouse between the strap and the frame.

37. The method of claim 35 wherein adjusting the size of the opening further comprises moving a point of connection between the strap and the frame.

38. The method of claim 35 wherein adjusting the size of the opening further comprises moving at least two points of connection between the strap and the frame.

39. The method of claim 35 wherein adjusting the size of the opening further comprises disengaging the strap from at least one mast.

40. The method of claim 39 wherein adjusting the size of the opening further comprises engaging the strap to at least one mast located in a first direction.
